(19) United States
(12) Patent Application Publication
(10) Pub. No.: US 2010/0242554 A1
(43) Pub. Date: Sep. 30, 2010

(54) LOCKING METHOD, SYSTEM AND KIT FOR A MOTORCYCLE

(76) Inventor: Efraeyim Hogesta, Moshav Burgata (IL)

Correspondence Address: SUGHRUE MION, PLLC, 2100 PENNSYLVANIA AVENUE, N.W., SUITE 800, WASHINGTON, DC, 20037, US

(21) Appl. No.: 12/740,632

(22) PCT Filed: Oct. 29, 2008
(86) PCT No.: PCT/IL08/01418

§ 371 Date: Apr. 29, 2010

Related U.S. Application Data
(60) Provisional application No. 60/983,594, filed on Oct. 30, 2007.

(51) Int. Cl. B62H 5/08; G05G 5/04; B62H 5/18

(52) U.S. Cl. 70/201; 70/204; 70/228

(57) ABSTRACT

A locking and/or throttle immobilization system (100) for a motorcycle, includes a lock and/or immobilization element (200), and a mounting unit (300). The mounting unit (300) is configured for being affixed to an end portion of a handlebar (23) and the lock/immobilization element (200) is configured for being detachably attached to the mounting unit (300). The lock comprises a locking element (150) formed as an integral body with a permanent slot (152) and configured for locking engagement to a disk-brake via the slot (152) when the lock is detached from said mounting unit. The lock can be the immobilization element. In some embodiments the immobilization element is not a lock, and the mounting unit is configured for being affixed to the handlebar that comprises the throttle control, and the mounting unit is further configured for at least partially immobilizing the throttle control when the immobilization element is detached from the mounting unit and for allowing full operation of the throttle control when the immobilization element is attached to the mounting unit.

### FIELD OF THE INVENTION

This present invention relates to methods and systems for immobilizing or locking a motorcycle used while not riding the motorcycle.

### BACKGROUND OF THE INVENTION

Many types of anti-theft and other locking devices for motorcycles are known. Perhaps the simplest security device known is a large chain, which can be looped through one of the wheels and/or a portion of the frame (interchangeably referred to also as chassis), and often also secured around a suitable stationary object such as a tree or lamp post. In another system, a chain or the like is connected between the handlebar and a rear portion of the motorcycle, preventing the handlebar from being turned. Other anti-theft arrangements for motorcycles include alarm systems with or without immobilizing systems, GPS assisted tracking systems, etc.

Another type of anti-theft device, commonly known as a disk-brake lock, is secured through one of the holes formed in the disk portion of a disk-brake, preventing rotation of the motorcycle wheel. Such locks are disclosed in U.S. Pat. No. 5,265,451 and U.S. Pat. No. 5,492,206, the contents of which are incorporated in their entirety herein.

U.S. Pat. No. 7,316,302, the contents of which are incorporated in their entirety herein, discusses a number of disadvantages sometimes encountered in practice using regular disk brake locks. For example, the rider may forget (or may sometimes not know, for example when the driver is unauthorized to drive the vehicle) that the lock is engaged and may attempt to travel on the motorcycle with the disk brake lock in place. At first the wheels may rotate, but as soon as the disk-brake lock comes into contact with the brake caliper or some other part of the motorcycle, that wheel will abruptly stop rotating, often causing damage to the motorcycle and/or injury or worse to the occupant(s) or others close by. Furthermore, disk-brake locks are often heavy and bulky and are therefore difficult to transport when the motorcycle is in use, and therefore a suitable storage location is required for this particular style of locks. A disk-brake lock is commonly stored in a pouch or storage bin attached to the chassis of the motorcycle, in the helmet compartment, or similar storage devices, which are extremely inconvenient, or are carried by the operator.

The aforesaid U.S. Pat. No. 7,316,302, to the present inventor, discloses inter alia a motorcycle disk-brake locking system for a motorcycle, including a lock detachably connected to a mounting unit that is fixable to the motorcycle, the lock being suitable for locking engagement to a disk-brake of the motorcycle. The lock is further configured as a functional component of the motorcycle as required for at least one of starting and driving the motorcycle when connected to said mounting unit, such that whenever the functional component is detached from the mounting unit, the mounting unit in the absence of the functional component provides a prompt to alert the user, at least when attempting to start or drive the motorcycle, that the functional component is not connected to the mounting unit.

The following publications are also provided by way of general background interest: U.S. Pat. No. 4,346,619, U.S. Pat. No. 4,436,232, U.S. Pat. No. 5,109,686, U.S. Pat. No. 5,127,562, U.S. Pat. No. 5,265,451, U.S. Pat. No. 5,492,206, U.S. Pat. No. 5,662,255, U.S. Pat. No. 5,823,025, U.S. Pat. No. 6,131,427, U.S. Pat. No. 6,178,787, U.S. Pat. No. 6,230,530, U.S. Pat. No. 6,553,793, U.S. Pat. No. 6,663,129, US 2003/0188938, US 2007/0022791, DE 20002685, EP 0716007, NL 9300794, GB 2371079, FR 2862599, Luma catalog for XMART motorcycle lock.

### SUMMARY OF THE INVENTION

According to a first aspect of the invention, there is provided a locking system for a motorcycle, comprising a lock and a mounting unit, wherein:

said mounting unit is configured for being affixed to an end portion of a handlebar of the motorcycle and said lock is configured for being detachably attached to said mounting unit; and

wherein said lock comprises a locking element formed as an integral body with a permanent slot and configured for locking engagement to a disk-brake of the motorcycle via said slot when said lock is detached from said mounting unit.

The locking element may comprise a pin reciprocable between a locked position traversing said slot and an open position wherein to clear said slot, said pin being operatively connected to a locking arrangement operable by a key, and wherein said pin comprises a diameter smaller than a diameter of at lest one hole provided in a disk brake of the motorcycle. In at least some embodiments the mounting unit comprises an elongate member projecting from a base member, and wherein said lock is configured for being detachably attachable to said mounting unit via engagement of said slot with said elongate member. The slot typically comprises a thickness dimension substantially greater than a respective thickness of said disk-brake. In this and other aspects of the invention, by “key” is meant any implement for selectively locking and unlocking the locking arrangement thereof, thus enabling the lock element to be locked and unlocked from either the mounting element or the disk brake. Thus, the aforesaid may take the form of a mechanical tool separate from the lock element, and inserted into a key channel provided in the locking arrangement for example, or alternatively the locking arrangement may take the form of a combination lock and thus the key comprises the opening combination, or alternatively the key comprises any other suitable configuration.

In at least some embodiments, the locking element may comprise a generally prismatic form having a central axis, wherein said slot is formed generally parallel with respect to, and offset from, said axis such as to provide a generally U-shaped form having said slot formed between arms of the locking element for embracing a portion of the disk-brake of the motorcycle. In at least some other embodiments the locking element comprises a generally prismatic form having a central axis, wherein said slot is formed generally orthogonal with said axis such as to provide generally U-shaped form having said slot formed between arms of the locking element for embracing a portion of the disk-brake of the motorcycle. In any case, the disk-receiving slot extends between two parallel walls of the arms. For example, the prismatic form comprises any one of a cylindrical form, a frustro-conical form, a truncated spherical form, and so on.

Optionally, the locking element comprises a stop laterally projecting from a surface of said prismatic form in a direction away said central axis, said stop configured for trapping a utility ring between said locking element and said mounting unit, when attached thereto and/or for trapping said utility ring between said locking element and said disk brake, when attached thereto. For example, the stop may comprise a raised key-receiving portion of the locking arrangement, or an annular shoulder. The utility ring may have any one of a plurality of uses or functions. For example, the utility ring may comprise a cable configured for attachment to a desired anchor point on the motorcycle or external thereto.

In at least some embodiments, the system is further configured for replacing a balance weight of the motorcycle originally supplied and carried at an end of the handlebar thereof, the system comprising a weight similar to a weight of the balance weight. Thus, in drive mode, when the motorcycle is being ridden, the system operates in a similar manner to that of the original balance weight, while in locked mode, when the motorcycle is parked, the system operates as an anti-theft device to lock a disk brake of the motorcycle.

In at least some embodiments, the system further comprises a throttle immobilization arrangement, configured for at least partially immobilizing the throttle control of said motorcycle when said locking element is detached from said mounting unit and for allowing full operation of the throttle control when said locking element is detached from said mounting unit. In particular, the mounting unit comprises a mechanical arrangement, or a non-powered arrangement, in particular a non-electrically powered arrangement, configured for selectively at least partially mechanically immobilizing and for selectively allowing full operation of said throttle control. In other words, the mechanical arrangement configured for selectively mechanically locking said throttle control for preventing at least opening of the throttle when said immobilization element is detached from said mounting unit. The mounting unit comprises a first part configured for being affixed to a rotating portion of the throttle control for rotating therewith, and a second part configured for being affixed to a static portion of the throttle control, wherein in operation of the throttle control said rotating portion is rotated with respect to said static portion, and further comprising a mechanical stop being selectively movable between a first position and a second position, wherein in said first position said first part is at least partially immobilized with respect to said second part, and wherein in said second position said first part is allowed to freely rotate with respect to said second part, and wherein said mechanical stop is configured to be urged to said second position responsive to said locking element being attached to said mounting unit.

In at least some embodiments, the at least partially immobilizing of the throttle control refers to and comprises immobilizing opening of said throttle control while allowing closing of said throttle control. For example, the first part comprises a ratchet ring arrangement having a plurality of ratchet teeth circumferentially disposed on said ring, and said stop comprises a pawl configured for being selectively engaged and disengaged with said ratchet teeth responsive to said locking element being attached to or detached from, respectively, said mounting unit, and wherein said ratchet teeth comprise a ramp portion and a stop portion to allow for rotational movement between said first part and said second part in a direction consistent with said closing of said throttle control when said pawl is engaged with said ratchet ring.

In at least some other embodiments, the at least partially immobilizing said throttle control comprises immobilizing opening and closing of said throttle control. For example, the first part comprises a ratchet ring arrangement having a plurality of ratchet teeth circumferentially disposed on said ring, and said stop comprises a pawl configured for being selectively engaged and disengaged with said ratchet teeth responsive to said locking element being attached to or detached from, respectively, said mounting unit, and wherein said ratchet teeth are configured for preventing rotational movement between said first part and said second part in a direction consistent with said opening or said closing of said throttle control when said pawl is engaged with said ratchet ring.

The pawl is biased in an engagement position with the ratchet teeth in the absence of the locking element from the mounting unit, typically by means of a spring or the like. In variations of the embodiment, the ratchet/pawl arrangement may be replaced any suitable mechanical stop arrangement that is biased into a locking position to mechanically lock the first and second parts when the locking element is removed from the mounting unit.

The system according to at least some embodiments comprises an adapter having a fitting part which is inserted between the flexible outer sleeve and the rigid pipe of the throttle control. After assembly the toothed ratchet ring has the teeth pointing outwardly, away from the throttle control. A spring urges the pawl to lock the throttle by pressing against the toothed part, unless locking element is locked in place, which then also acts as a balance weight when driving the motorcycle.

According to this aspect of the invention there is also provided a handlebar balance weight replacement kit for a motorcycle, the motorcycle comprising a balance weight unit on at least one end of a respective handlebar of the motorcycle, said kit comprising a locking system as defined herein, wherein said locking system has a weight substantially similar to a weight of the balance weight unit, and wherein said locking system is configured for being affixed to said respective handlebar after said balance weight unit is removed therefrom.

According to a second aspect of the invention there is provided a throttle immobilization system for a motorcycle, comprising an immobilization element and a mounting unit, wherein:

said mounting unit is configured for being affixed to an end portion of a handlebar comprising the throttle control of the motorcycle and said immobilization element is configured for being detachably attached to said mounting unit; and

wherein said mounting unit is configured for selectively at least partially immobilizing said throttle control in a mechanical manner when said immobilization element is detached from said mounting unit and for selectively allowing full operation of the throttle control when said immobilization element is detached from said mounting unit.

In particular, the mounting unit comprises a mechanical arrangement configured for selectively at least partially immobilizing and allowing full operation of said throttle control. In other words, the mechanical arrangement configured for selectively mechanically locking said throttle control for preventing at least opening of the throttle when said immobilization element is detached from said mounting unit. The mounting unit comprises a first part configured for being affixed to a rotating portion of the throttle control for rotating therewith, and a second part configured for being affixed to a static portion of the throttle control, wherein in operation of the throttle control said rotating portion is rotated with respect to said static portion, and further comprising a mechanical stop being selectively movable between a first position and a second position, wherein in said first position said first part is at least partially immobilized with respect to said second part, and wherein in said second position said first part is allowed to freely rotate with respect to said second part, and wherein said mechanical stop is configured to be urged to said second position responsive to said immobilization element being attached to said mounting unit.

In at least some embodiments, the at least partially immobilizing said throttle control refers to and comprises immobilizing opening of said throttle control while allowing closing of said throttle control. For example, the first part comprises a ratchet ring arrangement having a plurality of ratchet teeth circumferentially disposed on said ring, and said stop comprises a pawl configured for being selectively engaged and disengaged with said ratchet teeth responsive to said immobilization element being attached to or detached from, respectively, said mounting unit, and wherein said ratchet teeth comprise a ramp portion and a stop portion to allow for rotational movement between said first part and said second part in a direction consistent with said closing of said throttle control when said pawl is engaged with said ratchet ring. The pawl is biased in an engagement position with the ratchet teeth in the absence of the immobilization element from the mounting unit, typically by means of a spring or the like. In variations of the embodiment, the ratchet/pawl arrangement may be replaced any suitable mechanical stop arrangement that is biased into a locking position to mechanically lock the first and second parts when the immobilization element is removed from the mounting unit.

In at least some other embodiments, the at least partially immobilizing said throttle control refers to and comprises immobilizing opening and closing of said throttle control. For example, the first part comprises a ratchet ring arrangement having a plurality of ratchet teeth circumferentially disposed on said ring, and said stop comprises a pawl configured for being selectively engaged and disengaged with said ratchet teeth responsive to said immobilization element being attached to or detached from, respectively, said mounting unit, and wherein said ratchet teeth are configured for preventing rotational movement between said first part and said second part in a direction consistent with said opening or said closing of said throttle control when said pawl is engaged with said ratchet ring.

Optionally, the immobilization element according to this aspect of the invention is in the form of a lock, configured for being detachably attached to said mounting unit, and wherein said lock comprises a locking element formed as an integral body with a permanent slot and configured for locking engagement to a disk-brake of the motorcycle via said slot when said lock is detached from said mounting unit. The locking element may comprise a pin reciprocable between a locked position traversing said slot and an open position wherein to clear said slot, said pin being operatively connected to a locking arrangement operable by a key, and wherein said pin comprises a diameter smaller than a diameter of at lest one hole provided in a disk brake of the motorcycle. In at least some embodiments, the mounting unit comprises an elongate member projecting from a base member, and wherein said lock is configured for being detachably attachable to said mounting unit via engagement of said slot with said elongate member. Typically, the slot comprises a thickness dimension substantially greater than a respective thickness of said disk-brake. In at least some embodiments, the locking element comprises a generally prismatic form having a central axis, wherein said slot is formed generally parallel with respect to, and offset from, said axis such as to provide a generally U-shaped form having said slot formed between arms of the locking element for embracing a portion of the disk-brake of the motorcycle. In at least some other embodiments, the locking element comprises a generally prismatic form having a central axis, wherein said slot is formed generally orthogonal with said axis such as to provide generally U-shaped form having said slot formed between arms of the locking element for embracing a portion of the disk-brake of the motorcycle. The disk-receiving slot extends between two parallel walls of the arms. For example, the prismatic form comprises any one of a generally cylindrical form, a generally frustro-conical form, a truncated generally spherical form.

Optionally, the locking element comprises a stop laterally projecting from a surface of said prismatic form in a direction away said central axis, said stop configured for trapping a utility ring between said locking element and said mounting unit, when attached thereto and/or for trapping said utility ring between said locking element and said disk brake, when attached thereto. For example, the stop may comprise a raised key-receiving portion of the locking arrangement, or an annular shoulder. For example, the utility ring comprises a cable configured for attachment to a desired anchor point on the motorcycle or external thereto.

In at least some embodiments, the system is configured for replacing a balance weight of the motorcycle carried at an end of the handlebar thereof, the system comprising a weight similar to a weight of the balance weight.

According to the second aspect of the invention there is also provided a handlebar balance weight replacement kit for a motorcycle, the motorcycle comprising a balance weight unit on at least one end of a respective handlebar of the motorcycle, said kit comprising an immobilization system as defined herein, wherein said immobilization system has a weight substantially similar to a weight of the balance weight unit, and wherein said immobilization system is configured for being affixed to said respective handlebar after said balance weight unit is removed therefrom.

According to another aspect of the invention there is provided a motorcycle comprising at least one locking system and/or at least one immobilization system as defined herein.

According to another aspect of the invention there is provided a method for modifying a motorcycle comprising a handlebar and at least one brake disk, the method comprising the steps of (a) providing at least one locking system and/or at least one immobilization system as defined herein, and (b) affixing the system to an end of the handlebar. Prior to step (b), a balance weight originally provided at said end of the handlebar is removed and replaced with the respective locking and/or immobilization system.

Thus, a locking and/or throttle immobilization system is provided for a motorcycle, including a lock and/or immobilization element, and a mounting unit. The mounting unit is configured for being affixed to an end portion of a handlebar of the motorcycle and the lock/immobilization element is configured for being detachably attached to the mounting unit. The lock comprises a locking element formed as an integral body with a permanent slot and configured for locking engagement to a disk-brake of the motorcycle via the slot when the lock is detached from said mounting unit. In some embodiments the lock is also the immobilization element, while other embodiments include the immobilization element which is not a lock, and the mounting unit is configured for being affixed the handlebar that comprises the throttle control, and the mounting unit is further configured for at least partially immobilizing the throttle control when the immobilization element is detached from the mounting unit and for allowing full operation of the throttle control when the immobilization element is detached from the mounting unit.

Thus, according to at lest some aspects of the invention, there is provided a system, in a form of a device, that alternately operates as a lock (locked mode), when the motorcycle is parked or not ridden, and as a handlebar balancer while the motorcycle is being ridden (drive mode). In locked mode, the motorbike is protected by the lock and/or by the immobilization system that locks the throttle control.

According to aspects of the invention, in which a lock is mountable to the mounting unit, or where the immobilization element is in the form of a lock, which in either case comprises the aforesaid locking element, providing the aforesaid locking element as an integral body with a permanent slot configured for locking engagement to a disk-brake of the motorcycle via said slot when said lock is detached from said mounting unit provides a simple, durable low cost item, that is simple to operate with respect to the disk brake and to mount to the mounting unit, as well as being simple to produce.

It should be noted that according to aspects of the invention in which an integrated locking and immobilization system is provided, i.e., where the locking element is also configured as the immobilization element, if a rider forgets to remove the locking element from the disk brake, the rider cannot accidentally start riding the motorcycle and thereby damage the motorcycle, since the throttle control is immobilized by virtue of the fact that the locking element is detached from the mounting unit. Rather, the rider must first engage and lock the lock onto its designated location, the mounting unit, to mechanically release the throttle control, thus ensuring that the locking element is removed from the wheel brake. Thus, the system does not have to rely on the user being prompted to remember that the locking element is engaged to the disk brake, but rather also provides a mechanical immobilization system that prevents normal driving of the motorcycle so long as the locking element is detached therefrom, and which in normal operation is engaged to the disk brake, forcing the user to disengage the locking element from the disk brake and attaching to the mounting unit before driving can commence.

It should be further noted that according to aspects of the invention the locking and/or immobilization system is provided as a retrofittable system, for use with any suitable motorcycle design, and which is furthermore non-complex and relatively simple to manufacture, install and operate.

According to at least some aspects of the invention, there is provided a system in the form of a device that enables to efficiently combine two motorcycle accessories into one. The device is used as a wheel disk brake lock, when the motorcycle is parked, and as part of a handlebar balancer set, when the motorcycle is in motion.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1a illustrates a motorcycle having a lock placed on the front wheel, according to embodiments of the present invention, and a handlebar balancer placed on the end of the motorcycle handlebar, according to embodiments of the present invention; FIG. 1b is a magnification of the device of the present invention being used as the handlebar balancer shown in FIG. 1a; FIG. 1c is a magnification of the device of the present invention being used as the lock shown in FIG. 1a.

FIG. 2 illustrates a prior art handlebar balancer.

FIG. 3 is an exploded view of the combined lock/balancer device, according to a first embodiment of the present invention.

FIG. 4 illustrates a motorcycle handle with a part of the embodiment of FIG. 3 installed therein.

FIG. 5 illustrates the embodiment of FIG. 3 in locked mode, the lock element being placed or removed from the wheel disc.

FIGS. 6a to 6c illustrate the embodiment of FIG. 3 in drive mode, being used as the handlebar balancer; FIG. 6a illustrates the handle bar comprising the embodiment of FIG. 3 absent the locking element; FIG. 6b illustrates the locking element mounted onto the mounting unit; and FIG. 6c illustrates the locking element locked onto the mounting unit.

FIG. 7a illustrates in partially fragmented side view, the embodiment of FIG. 3 in drive mode; FIG. 7b illustrates a partial section of the embodiment of FIG. 7a taken along A-A; FIG. 7c illustrates the embodiment of FIG. 7b in locked mode.

FIGS. 8a, 8b, 8c illustrate the embodiment of FIG. 3 being used for engaging a system thereto comprising an engagement ring; FIG. 8a illustrates the handle bar comprising the embodiment of FIG. 3 absent the locking element; FIG. 8b illustrates the locking element mounted onto the mounting unit and trapping the system between the locking element and the handlebar; and FIG. 8c illustrates the locking element locked onto the mounting unit.

FIG. 9 illustrates a second embodiment of the invention.

FIG. 10a and FIG. 10b illustrate a variation of the embodiment of FIG. 3 in drive mode and locked mode, respectively.

FIG. 11 illustrates a third embodiment of the invention.

### DETAILED DESCRIPTION OF EMBODIMENTS

Before disclosing embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

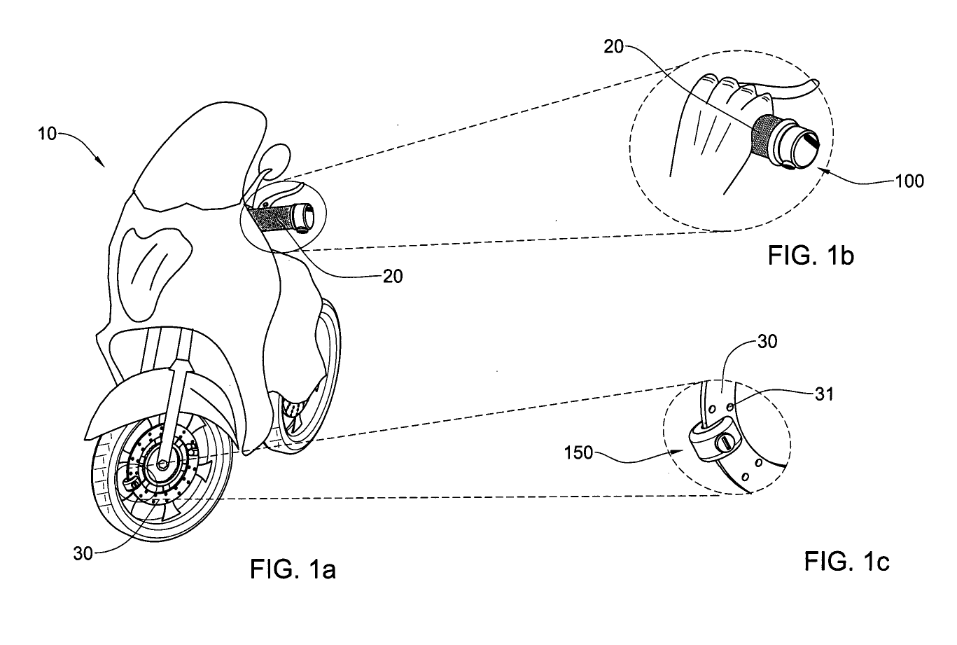

Referring to FIG. 3, a locking system for a motorcycle according to a first embodiment of the invention, in the form of a device generally designated 100, comprises a lock 200 and a mounting unit 300. FIG. 1a, which is illustrative and combines various modes of operation in a single figure, illustrates a motorcycle 10 in lock mode, wherein lock 200 placed in locking arrangement with respect to the brake disk 30 of the front wheel, shown in greater detail in FIG. 1c, and also in driving mode, wherein the lock 200 is attached via the mounting unit 300 and also acts as a handlebar balancer placed on the end of the handlebar 20 of the motorcycle, shown in greater detail in FIG. 1b. As will become clearer herein, in normal operation the device 100 as a whole is configured for operating in one or another of lock mode and driving mode, but not both modes at the same time.

Referring again to FIG. 3, mounting unit 300 comprises a movable portion 310 and a fixed portion 320, and lock 200 comprises lock element 150 including key 160.

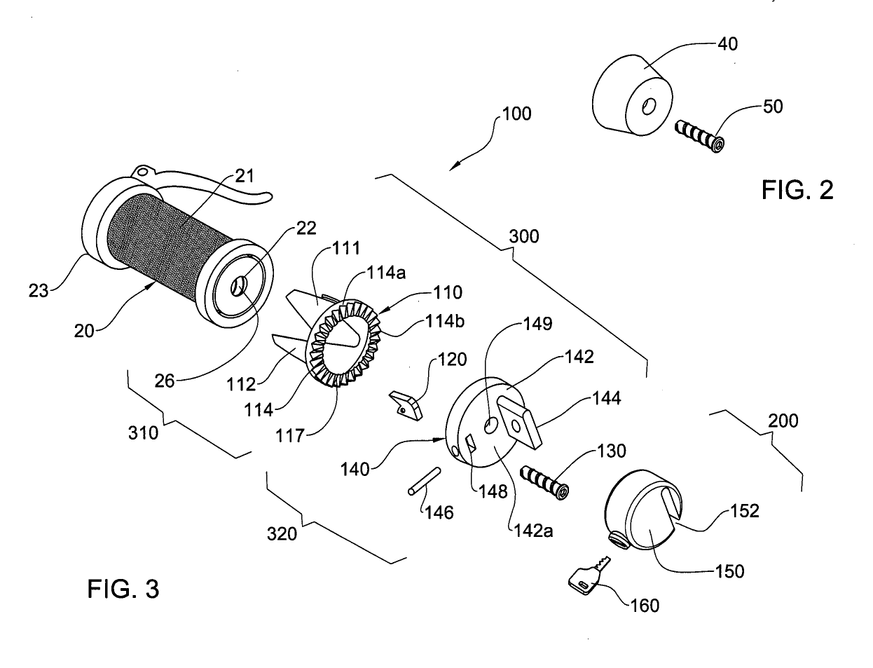

The throttle control 20 of the motorcycle 10 comprises a handle 21 that is rotatably mounted with respect to an inner static portion 22 of the handlebar 23, so that in normal operation of the throttle control, the rider rotates the handle 21 with respect to portion 22 to open or close the engine throttle (not shown). Also referring to FIG. 2, in one specific type of motorcycle 10, the handlebars are normally initially fitted with a pair of balance weights 40, one each being mounted to a threaded bore 26 at the end of the respective left or right handle 21 via screw 50. As will become clearer herein, at least one balance weight 40 is replaced with device 100.

The movable portion 310 comprises an adapter 110, which comprises a plurality of pretensioned prong elements 111, 112 which longitudinally extend from a first side 114a of an annular base element 114 and are configured to provide a press-fit, nominally permanent connection with the inner cylindrical surface of the handle 21, while providing a clearance with respect to static portion 22. Thus, whenever the handle 21 is rotated to operate the throttle, the movable portion 310 rotates with the handle. In alternative variations of the embodiment, the adaptor 110 may comprise, instead of the prong elements, a cylindrical sleeve adapted to provide a press fit, or adapted to provide a threaded mount or bayonet mount or an expansion mount with respect to the handle 21, which is modified for this purpose. In yet other variations of this embodiment, the adapter 110 may be welded, soldered, bonded or in any other manner connected to the handle 21. The annular base element 114 also comprises a second annular side 114b.

The fixed potion 320 comprises lock holder 140, which comprises a substantially disc-like base element 142, having an outer facing surface 142a with a central through hole 149, and a locking bar 144 that longitudinally projects from the surface 142a, offset with respect to hole 149. The fixed portion 320 is configured to provide a nominally permanent connection with the portion 22, in this embodiment by engaging screw 130 (being similar to screw 50, but may be of different length, and thus effectively replaces screw 50; alternatively screw 50 may be reused in place of screw 130), though in other variations of this embodiment, different affixing methods may be used for securing the fixed portion with respect to portion 22. Thus, lock holder 140 is typically affixed to the standard internal threads of throttle control 20, via screw 130. In its fixed position, the inner side 142b is seated abutting the second side 114b, and in driving mode side 142b may rotate with respect to side 114b as the handle 21 is rotated to operate the throttle.

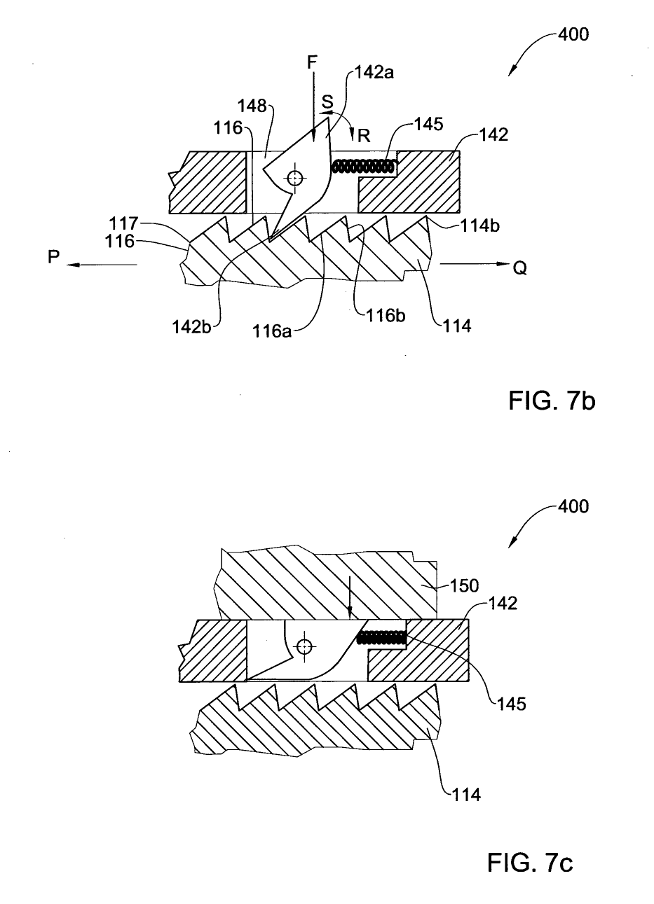

Referring also to FIG. 7a, the lock element 150 comprises a prismatic body, and is formed, in this embodiment, as an integral, generally cylindrical solid body or the like, having a chordwise slot 152 formed therein, parallel to and offset with respect to the centerline CL, to provide a C-shaped component. The lock element 150 further comprises a chordwise locking mechanism or arrangement 155 that is operable by means of key 160. By “integral” is meant that the lock element 150 operates as a single body during drive mode, during locking mode, and also in the transition between the two modes, facilitating operation thereof; however, while lock element 150 is in the form of a unitary component in this embodiment, in variations of this embodiment the lock element 150 may alternatively be made from several pieces joined to one another, but no disassembly and assembly of the pieces is required for enabling the lock element 150 to be engaged and locked, or unlocked and disengaged, either with respect to the disk 30 or to the lock holder 144.

There are many examples in the art of locking arrangements which may be suitable as locking arrangement 155, and will not be described further herein, other than to state that in this embodiment, the locking arrangement comprises a reciprocable pin 151 that traverses the slot 152 when the locking arrangement is locked, and conversely retracts the pin 151 from the slot 152 when the locking arrangement is unlocked. The slot 152 is configured for enabling the lock element 150 to be engaged to a disk portion 30 of the motorcycle's disk-brake by inserting part of the disk portion 30 into the slot 152 (when the locking arrangement is unlocked), and then locking the lock in place by inserting pin 151 into one of the holes 31 that exist in the disk portion 30, by locking the locking arrangement. Locking and unlocking locking arrangement 155 is via key 160, and many different configurations thereof are known in the art.

In this embodiment, the device 100 effectively replaces the balance weight 40 that is originally fitted to one handle 21 of the motorcycle 10 and thus has a comparable weight to balance weight 40. In some variations of this embodiment, the device 100 may have a weight that is greater than or less than that of the balance weight 40.

In this embodiment, the device 100 further comprises an immobilization arrangement 400, which when actuated selectively immobilizes, in a simple and mechanical manner, at least part of the operation of the throttle control. The immobilization arrangement 400 includes a pawl 120 housed in a chordwise slot 148 extending from side 142a to side 142b included in the fixed portion 320, the pawl 120 being pivoted therein by means of pin 146. The immobilization arrangement 400 also comprises a ratchet wheel 117 formed on the base element 114, which comprises a plurality of ratchet teeth 116 following one another around the annular side 114b. Each tooth 116 is shaped to allow relative rotational movement between the pawl 120 and the ratchet ring 117, when mutually engaged, in a direction correlated with reducing the throttle, while preventing rotation in the opposite direction, i.e. to open the throttle, when the device 100 is in lock mode, as will become clearer herein. The teeth 116 each have a ramp 116a on one side thereof, followed by a sharp stop 116b on the other side thereof, along a circumferential direction.

The pawl 120 is biased to the engaged or open position illustrated in FIG. 7b (consistent with lock mode) by means of spring 145, in which a first end 120a of the pawl 120 projects outwardly from the side 142a, while second end 142b is engaged between adjacent teeth 116 of ratchet wheel. Movement in direction P for the base element 114 is possible if the handle 21 is turned in this direction (consistent with reducing the throttle), but engagement of the pawl 120 with stop 116b prevents movement in direction Q, and thus prevents the handle from being turned in a direction to open the throttle, thus immobilizing the same.

Referring to FIGS. 7a to 7c, when there is an external force F applied to the protruding end 142a in an inner axial direction, the pawl 120 rotates in direction R, thereby disengaging the other end 142b from the ratchet wheel 116, and thus enabling free relative rotation between the movable portion 310 and the fixed portion 320 in either direction, enabling base 142 to slide over ratchet ring 114, allowing the throttle to be operated as normal, thereby allowing a rider to ride motorbike 10. In this embodiment, force F is applied by engaging the lock element 150 to the mounting unit 300 and locking it there via the locking arrangement, such that one of the faces 153 of the lock element 150 is abuttingly seated on side 142a, and wherein pin 151 now secures the lock element 150 to locking bar 144 via a hole 147 formed in the locking bar 144.

It is to be noted that force F may also be applied using any suitable mechanical analog, i.e., any mechanical device that is configured for providing the force F. Such an analog may comprise, for example, a spare lock element 150, or another shaped bracket or tool, or adhesive tape or the like that can be used for pressing the pawl 120 and providing disengagement of the same. Furthermore, in variations of this embodiment, the pawl and spring may be replaced with a leaf spring or any other arrangement that is biased into a position locking the movable portion 320 in the absence of force F provided by the locking element 150, for example.

Thus, by pressing against the ratchet ring 117, pawl 120 locks the throttle control and prevents this from opening, unless intentionally released by engaging the lock element 150 onto locking bar 144 or via any suitable mechanical analog.

This form of the mechanical immobilization arrangement 400 also provides a safety feature in that it allows the motorcycle to throttle down, but not throttle up, when the lock element 150 is removed from the mounting unit 300. Thus, if for example the lock element 150 is removed from the mounting unit 300 while the throttle is still open, the throttle may be closed down safely without having to first re-engage the lock element 150 to the mounting unit 300. Furthermore, the arrangement 400, when the lock element 150 is removed thereof, prevents opening the throttle, and thus even if the ignition circuit is not operational (and thus the motorcycle cannot in any case be started), this prevents fuel from being wasted, for example as may otherwise happen by careless turning of the throttle control.

While a mechanical analog may be used for disabling the immobilization arrangement 400, it is unlikely that the authorized rider would do so while the lock element 150 is still engaged in the disk brake, as this would still prevent the motorcycle from being rolled.

In other variations of this embodiment, the immobilization arrangement does not allow any operation (opening or closing) of the throttle in the absence of force F, nominally when the lock unit 150 is disengaged from the mounting unit 300. For example, a toothed ring may be provided similar to ratchet ring 117, but with the teeth not having any ramp portions, mutatis mutandis.

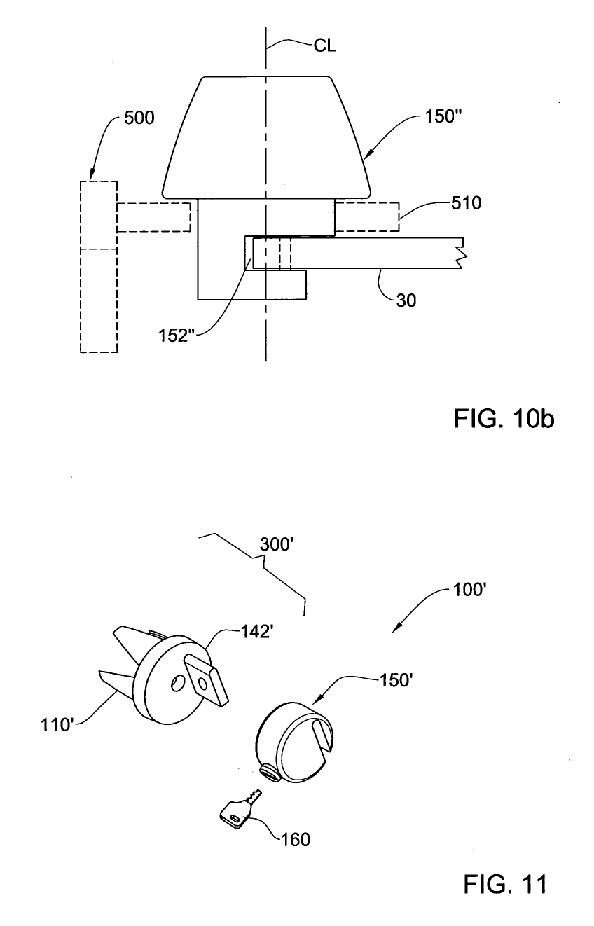

In a variation of the first embodiment, and referring to FIGS. 10a and 10b, the lock element, herein designated as 150″, comprises a slot 152″ that is nominally orthogonal to the centerline CL of the lock element 150″, and engages to a complementary shaped locking bar 144″ provided on static part 320″. The locking arrangement 155″ and key 160 are nominally aligned with the centerline or axis CL.

Operation of the device is as follows.

Before assembling device 100 onto the handlebar, the standard, prior art balancer unit 40 is removed, as shown in FIG. 2, by unscrewing screw 50.

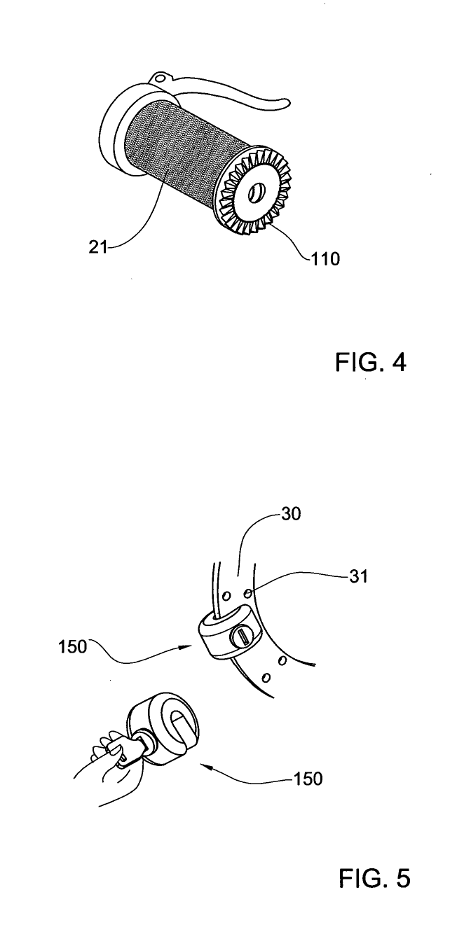

Device 100 is preferably attached to the right hand handle 21 of the handlebar 23, where throttle control 20 is located, to provide locking of throttle control 20 when device 100 is not completely assembled in place. When assembled, prongs 111, 112 are inserted between the flexible outer sleeve, typically made of rubber, of the handle 21, and the rigid pipe of throttle control 20 onto which the outer sleeve is normally attached. FIG. 4 illustrates a motorcycle throttle control 20 in which after assembly of the movable part 31, the serrated form of the ratchet wheel 117 is seen, with the teeth 116 pointing outwardly, away from throttle control 20.

When lock unit 150 is locked onto part 144, the device 100 is used as a balancer in place of original balance weight 40.

Device 100 is operated alternately either as a disk lock when the motorcycle is parked (locked mode), or as a handlebar balancer when the motorcycle is to be driven or rolled (drive mode).

In locked mode, to operate lock/balancer device 100 as a disk lock, lock element 150 is placed on disk 30 via slot 152, and key 160 locks lock element 150 in place, as shown in FIGS. 1a and 1c. In locked mode, motorbike 10 is protected both by lock 150 on the disk brake in a similar manner to many other prior art lock brake systems, and further by immobilizing the throttle control by means of the immobilization arrangement 400. Reference is now made to FIG. 5, which illustrates lock element 150 being placed on or removed from wheel disk 30.

In drive mode, wherein the lock/balancer device 100 also operates as a balancer, weight element 150 is removed from wheel disk 30 and subsequently engaged onto locking bar 144 (and locked therein by key 160), wherein this ensures that the pawl 120 is depressed and rotates in direction R into the cavity 148, disengaging from ratchet ring 117 and effectively turning off the immobilization arrangement 400.

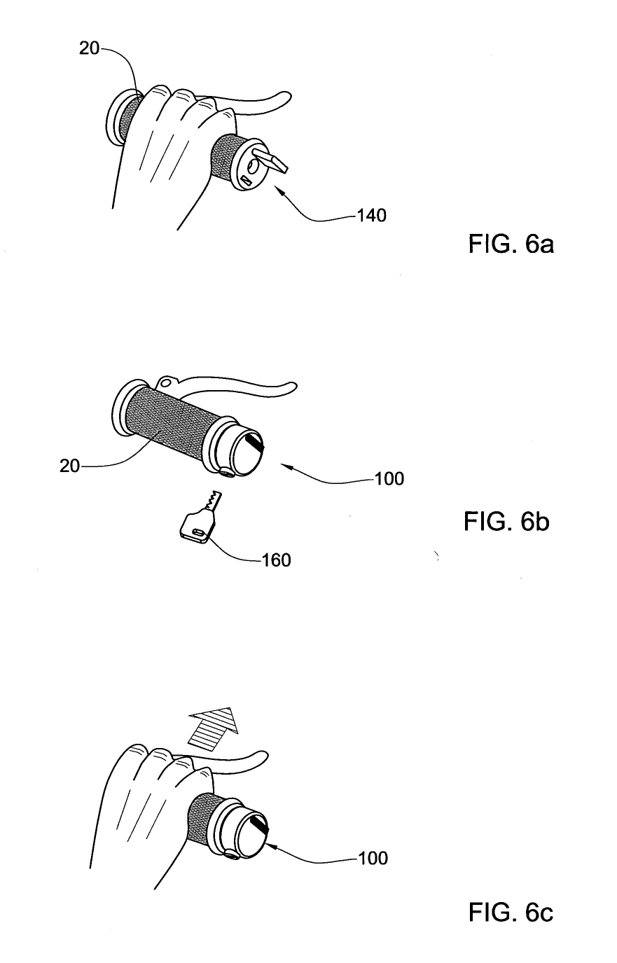

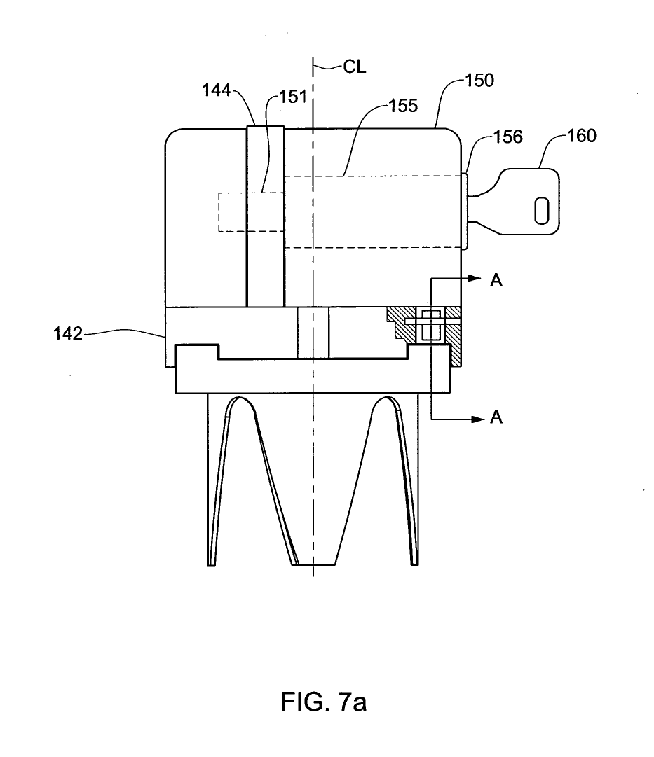

Reference is also made to FIG. 6a, which illustrates device 100 having the lock element 150 removed; to FIG. 6b, which illustrates lock element 150 being engaged and locked onto the handle 21; and to FIG. 6c, which illustrates lock/balancer device 100 assembled in place and operated as balancer and allowing motorbike 10 to be set in motion.

It should be noted that if a rider forgets to remove lock element 150 from wheel disk 30, the rider cannot accidentally start riding motorbike 10 and thereby damage the wheel of motorbike 10 or cause other damage, or injuring the rider or others. The rider must first lock the lock element 150 onto lock/weight holder 140 to release throttle control 20.

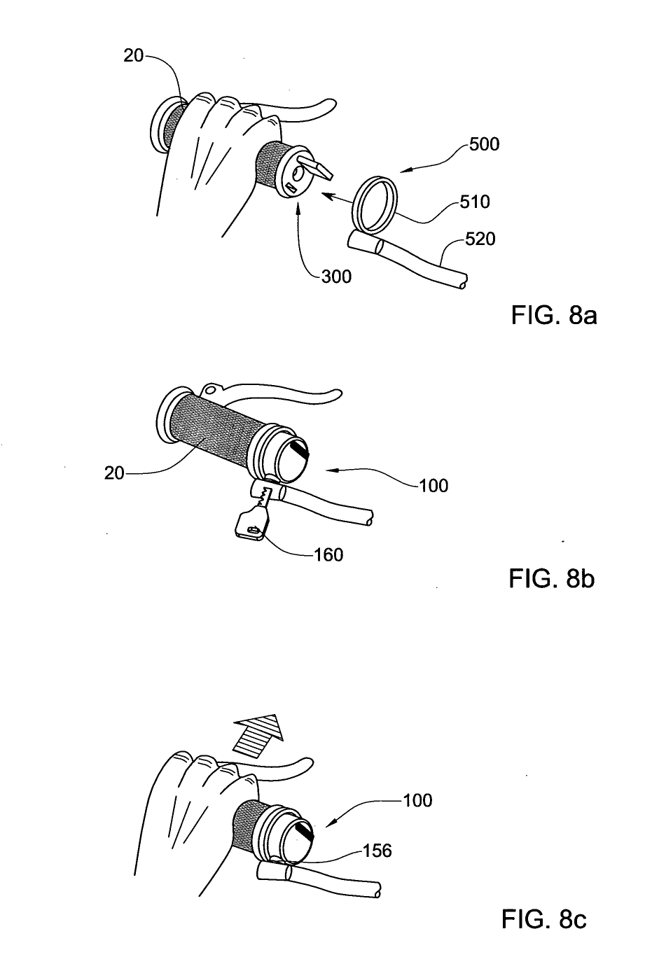

It is to be noted that in this embodiment, the locking arrangement 155 comprises an outer key-receiving disk portion 156 that radially protrudes from the cylindrical side of the locking element 150. Referring to FIGS. 8a to 8c, the device 100 may also be used for locking in place a utility ring 510, which is part of a system 500 that may be configured for a number of uses, for example for releasably attaching a cable 520 to the device 100 via the ring 510. The cable may be looped onto the ring 520 to enable helmets etc. to be hung from the handlebar, for example. First, the ring 510, which has a diameter just larger than that of the locking element 150, but by less than the protruding thickness of portion 156, is placed onto the mounting unit 300 (FIG. 8a), then the locking element 150 is engaged in place and locked as disclosed herein (FIG. 8b), and thereafter the rider may operate the motorcycle 10, while having the system 500 mounted in place. The ring 510 is prevented from coming off the handle 21 by the protruding portion 156 that acts as a stop. Detachment of the system 500 is essentially a reversal of the steps taken to attach the same. In a similar manner, in the variation of the first embodiment illustrated in FIGS. 10a and 10b, lock element 150″ comprises an annular shoulder 156″ circumscribing the cylindrical surface, which may be used for releasably attaching system 500 to the motorcycle by trapping ring 510 between the disk brake 30 and the shoulder 156″, or between the handle 21 and the shoulder 156″, as illustrated in FIGS. 10b and 10a, respectively.

In variations of this embodiment, in which the motorcycle 10 does not comprise a balance weight 40, the device 100 may nevertheless be adapted for mounting to the handle bar thereof. For example, if the handle 21 comprising the throttle control 20 has a rubber of plastic covering including the free end of the handle 21, the part of the rubber/plastic covering the free end can be cut, and the movable portion 310 affixed to the handle 21 in a similar manner to that described above, mutatis mutandis. If the handle bar has a portion 22 as described for the above embodiment, then the fixed portion 320 is fixed to the portion 22 in a similar manner to that described above, mutatis mutandis, or alternatively, the fixed portion is suitably fixed to an internal part of the handle that is static as the handle is turned to operate the throttle.

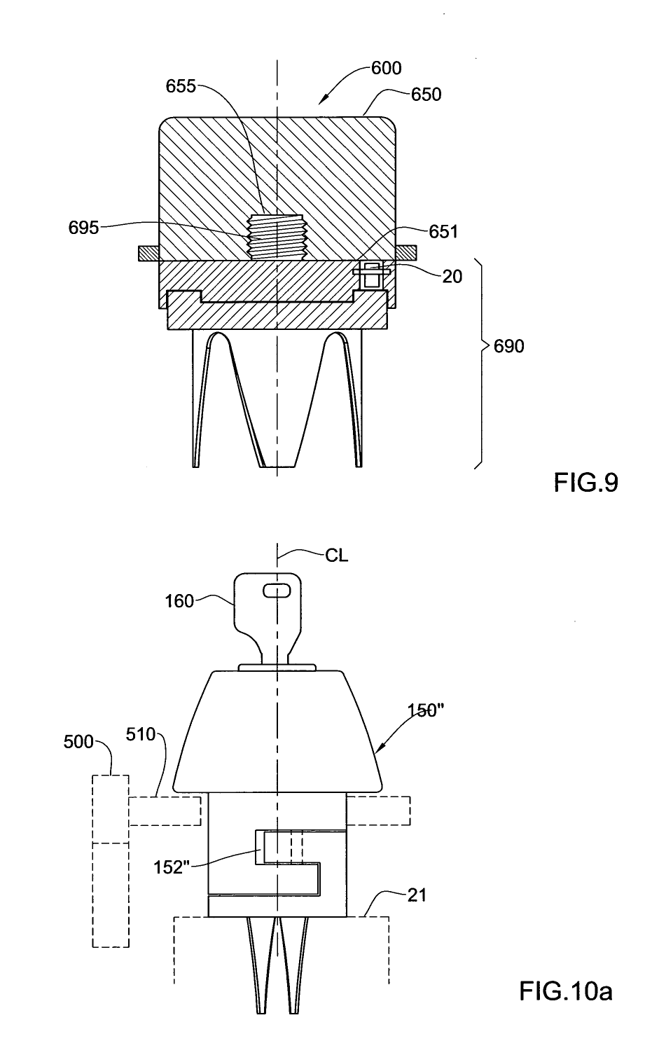

According to another aspect of the invention, the first embodiment of the invention, and variations thereof, may also be used exclusively as a throttle immobilizer, without necessarily locking the disk brake of a wheel in locked mode. Thus, once the motorcycle is stopped and parked, the device 100 may be operated by removing the lock element 150 from the mounting unit 300, which action automatically immobilizes the throttle control, but the lock element 150 is not then locked to the disk brake 30. The lock element may instead be stowed in a locked compartment in the motorcycle, or may be carried by the rider, for example. This alternative operation of the device 100 enables the user to immobilize the motorcycle without the need of locking it via the disk brake (for example when stopping somewhere for a short while only), or enabling the motorcycle to be locked using a different lock other than lock element 150. There is also provided, according to this aspect of the invention, a second embodiment of the device, illustrated in FIG. 9 and comprising all the elements and features of the first embodiment and variations thereof, mutatis mutandis, with the main difference being that the locking element of the first embodiment is replaced with a similar component, herein referred to as immobilizing element 650, that is not necessarily configured for locking engagement with the disk brake 30. Thus, in this embodiment, the device, designated with the reference numeral 600, comprises immobilizing element 650 and a mounting unit 690. The immobilizing element 650 and mounting unit 690 are similar to the lock 200 and the mounting unit 300, respectively, of the first embodiment, mutatis mutandis, with the main difference being that the immobilizing element 650 is engaged to the mounting unit 690 by means of a threaded connection—the immobilizing element 650 may comprises a solid block of material having a threaded well 655, which engages with a complementarily threaded stump 695 provided in the mounting unit 690. The immobilizing element, together with the rest of the device 600, can be made having comparable weight to the original balancer weight 40 of the motorcycle, and thus serve the function thereof when the motorcycle is being ridden. The immobilizing element 650 comprises an abutting surface 651 that abuts against the pawl 20 when the immobilizing element 650 is fully engaged with the mounting unit 690, enabling operation of the throttle as in the first embodiment, mutatis mutandis, and which results in immobilization of the throttle control when disengaged from the mounting unit. In other variations of the embodiment, the immobilizing element 650 may comprise any other suitable arrangement for engagement with mounting unit 690, such as to enable abutting surface 651 to then abuts against the pawl 20, and may comprise, for example, a bayonet fit or a slot and locking bar arrangement, for example as disclose for the first embodiment, mutatis mutandis. In these or other variations of the second embodiment, the immobilizing element 650 may be further configured for being locked in place, engaged with the mounting unit 690.

A third embodiment of the invention is illustrated in FIG. 11, and may be used instead of the first embodiment or variations thereof, or in addition to the first embodiment or variations thereof, in the latter case for locking the second wheel of the motorcycle. This second embodiment comprises all the elements and features of the first embodiment and/or variations thereof as disclosed herein, mutatis mutandis, with the main difference that the device, designated 100′, does not comprise an immobilization arrangement, and may thus be particularly adapted for being mounted to the other handle of the motorcycle that does not comprise the throttle control, typically the left-hand handle. In the embodiment of FIG. 11, the mounting unit 300′ is adapted to be fixed to the second handle 26 of the handlebars, and only comprises a fixed portion, which is similar to the fixed portion 320 of the first embodiment, mutatis mutandis, and has the adapter 110′, similar to adapter 110, mutatis mutandis, projecting from the base 142′ and configured for being fixed to the second handle 26. Furthermore, the embodiment of FIG. 11 does not comprise an immobilizing arrangement for immobilizing the throttle control when the weight element 150 is removed from the mounting unit. The embodiment of FIG. 11 operates in a similar manner to the first embodiment or variations thereof, mutatis mutandis, with the main difference that there is no immobilization of the throttle control when the weight element 150′ is removed from mounting unit 300′. Of course, the embodiment of FIG. 11 may alternatively be used with the handle that comprises the throttle control 20, but does not immobilize the same when the weight element 150′ is removed from the mounting unit 300′.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed example embodiments in accordance with the invention, it will be appreciated that many changes may be made therein without departing from the spirit of the invention.

1. A throttle immobilization system for a motorcycle, comprising an immobilization element and a mounting unit, wherein:
said mounting unit is configured for being affixed to an end portion of a handlebar comprising the throttle control of the motorcycle and said immobilization element is configured for being detachably attached to said mounting unit; and
wherein said mounting unit is configured for selectively at least partially immobilizing said throttle control mechanically when said immobilization element is detached from said mounting unit and for selectively allowing full operation of the throttle control when said immobilization element is detached from said mounting unit.

2. System according to claim 1, wherein said mounting unit comprises a mechanical arrangement configured for selectively mechanically locking said throttle control for preventing at least opening of the throttle when said immobilization element is detached from said mounting unit.

3. System according to claim 1, wherein said mounting unit comprises a first part configured for being affixed to a rotating portion of the throttle control for rotating therewith, and a second part configured for being affixed to a static portion of the throttle control, wherein in operation of the throttle control said rotating portion is rotated with respect to said static portion, and further comprising a mechanical stop being selectively movable between a first position and a second position, wherein in said first position said first part is at least partially immobilized with respect to said second part, and wherein in said second position said first part is allowed to freely rotate with respect to said second part, and wherein said mechanical stop is configured to be urged to said second position responsive to said immobilization element being attached to said mounting unit.

4. System according to claim 1, wherein said at least partially immobilizing said throttle control comprises immobilizing opening of said throttle control while allowing closing of said throttle control.

5. System according to claim 4, wherein said first part comprises a ratchet ring arrangement having a plurality of ratchet teeth circumferentially disposed on said ring, and said stop comprises a pawl configured for being selectively engaged and disengaged with said ratchet teeth responsive to said immobilization element being attached to or detached from, respectively, said mounting unit, and wherein said ratchet teeth comprise a ramp portion and a stop portion to allow for rotational movement between said first part and said second part in a direction consistent with said closing of said throttle control when said pawl is engaged with said ratchet ring.

6. System according to claim 1, wherein said at least partially immobilizing said throttle control comprises immobilizing opening and closing of said throttle control.

7. System according to claim 6, wherein said first part comprises a ratchet ring arrangement having a plurality of ratchet teeth circumferentially disposed on said ring, and said stop comprises a pawl configured for being selectively engaged and disengaged with said ratchet teeth responsive to said immobilization element being attached to or detached from, respectively, said mounting malt, and wherein said ratchet teeth are configured for preventing rotational movement between said first part and said second part in a direction consistent with said opening or said closing of said throttle control when said pawl is engaged with said ratchet ring.

8. System according to claim 1, wherein said immobilization element is in the form of a lock, configured for being detachably attached to said mounting unit, and wherein said lock comprises a locking element formed as an integral body with a permanent slot and configured for locking engagement to a disk-brake of the motorcycle via said slot when said lock is detached from said mounting unit.

9. System according to claim 8, wherein said locking element comprises a pin reciprocable between a locked position traversing said slot and an open position wherein to clear said slot, said pin being operatively connected to a locking arrangement operable by a key, and wherein said pin comprises a diameter smaller than a diameter of at lest one hole provided in a disk brake of the motorcycle.

10. System according to claim 8, wherein mounting unit comprises an elongate member projecting from a base member, and wherein said lock is configured for being detachably attachable to said mounting unit via engagement of said slot with said elongate member.

11. System according to claim 8, wherein said slot comprises a thickness dimension substantially greater than a respective thickness of said disk-brake.

12. System according to claim 8, wherein said locking element comprises a generally prismatic form having a central axis, wherein said slot is formed generally parallel with respect to, and offset from, said axis such as to provide a generally U-shaped form having said slot formed between arms of the locking element for embracing a portion of the disk-brake of the motorcycle.

13. System according to claim 8, wherein said locking element comprises a generally prismatic form having a central axis, wherein said slot is formed generally orthogonal with said axis such as to provide generally U-shaped form having said slot formed between arms of the locking element for embracing a portion of the disk-brake of the motorcycle.

14. System according to claim 12, wherein the disk-receiving slot extends between two parallel walls of the arms.

15. System according to claim 12, wherein said prismatic form comprises any one of a cylindrical form, a frustro-conical form, a truncated spherical form.

16. System according to claim 12, wherein said locking element comprises a stop laterally projecting from a surface of said prismatic form in a direction away said central axis, said stop configured for trapping a utility ring between said locking element and said mounting unit, when attached thereto and/or for trapping said utility ring between said locking element and said disk brake, when attached thereto.

17. System according to claim 16, wherein said utility ring comprises a cable configured for attachment to a desired anchor point on the motorcycle or external thereto.

18. System according to claim 12, wherein said system is configured for replacing a balance weight of the motorcycle carried at an end of the handlebar thereof, the system comprising a weight similar to a weight of the balance weight.

19. A handlebar balance weight replacement kit for a motorcycle, the motorcycle comprising a balance weight unit on at least one end of a respective handlebar of the motorcycle, said kit comprising an immobilization system as defined in claim 1, wherein said immobilization system has a weight substantially similar to a weight of the balance weight unit, and wherein said immobilization system is configured for being affixed to said respective handlebar after said balance weight unit is removed therefrom.

20. A locking system for a motorcycle, comprising a lock and a mounting unit, wherein:
said mounting unit is configured for being affixed to an end portion of a handlebar of the motorcycle and said lock is configured for being detachably attached to said mounting unit; and
wherein said lock comprises a locking element formed as an integral body with a permanent slot and configured for locking engagement to a disk-brake of the motorcycle via said slot when said lock is detached from said mounting unit.

21. System according to claim 20, wherein said locking element comprises a pin reciprocable between a locked position traversing said slot and an open position wherein to clear said slot, said pin being operatively connected to a locking arrangement operable by a key, and wherein said pin comprises a diameter smaller than a diameter of at lest one hole provided in a disk brake of the motorcycle.

22. System according to claim 20, wherein mounting unit comprises an elongate member projecting from a base member, and wherein said lock is configured for being detachably attachable to said mounting unit via engagement of said slot with said elongate member.

23. System according to claim 20, wherein said slot comprises a thickness dimension substantially greater than a respective thickness of said disk-brake.

24. System according to claim 20, wherein said locking element comprises a generally prismatic form having a central axis, wherein said slot is formed generally parallel with respect to, and offset from, said axis such as to provide a generally U-shaped form having said slot formed between arms of the locking element for embracing a portion of the disk-brake of the motorcycle.

25. System according to claim 20, wherein said locking element comprises a generally prismatic form having a central axis, wherein said slot is formed generally orthogonal with said axis such as to provide generally U-shaped form having said slot formed between arms of the locking element for embracing a portion of the disk-brake of the motorcycle.

26. System according to claim 24, wherein the disk-receiving slot extends between two parallel walls of the arms.

27. System according to claim 24, wherein said prismatic form comprises any one of a cylindrical form, a frustro-conical form, a truncated spherical form.

28. System according to claim 24, wherein said locking element comprises a stop laterally projecting from a surface of said prismatic form in a direction away said central axis, said stop configured for trapping a utility ring between said locking element and said mounting unit, when attached thereto and/or for trapping said utility ring between said locking element and said disk brake, when attached thereto.

29. System according to claim 28, wherein said utility ring comprises a cable configured for attachment to a desired anchor point on the motorcycle or external thereto.

30. System according to claim 20, wherein said system is configured for replacing a balance weight of the motorcycle carried at an end of the handlebar thereof, the system comprising a weight similar to a weight of the balance weight.

31. System according to claim 20, further comprising a throttle immobilization arrangement, configured for selectively at least partially immobilizing the throttle control of said motorcycle mechanically when said locking element is detached from said mounting unit and for selectively allowing full operation of the throttle control when said locking element is detached from said mounting unit.

32. System according to claim 31, wherein said mounting unit comprises a mechanical arrangement configured for selectively mechanically locking said throttle control for preventing at least opening of the throttle when said immobilization element is detached from said mounting unit.

33. System according to claim 31, wherein said mounting unit comprises a first part configured for being affixed to a rotating portion of the throttle control for rotating therewith, and a second part configured for being affixed to a static portion of the throttle control, wherein in operation of the throttle control said rotating portion is rotated with respect to said static portion, and further comprising a mechanical stop being selectively movable between a first position and a second position, wherein in said first position said first part is at least partially immobilized with respect to said second part, and wherein in said second position said first part is allowed to freely rotate with respect to said second part, and wherein said mechanical stop is configured to be urged to said second position responsive to said locking element being attached to said mounting unit.

34. System according to claim 31, wherein said at least partially immobilizing said throttle control comprises immobilizing opening of said throttle control while allowing closing of said throttle control.

35. System according to claim 34, wherein said first part comprises a ratchet ring arrangement having a plurality of ratchet teeth circumferentially disposed on said ring, and said stop comprises a pawl configured for being selectively engaged and disengaged with said ratchet teeth responsive to said locking element being attached to or detached from, respectively, said mounting unit, and wherein said ratchet teeth comprise a ramp portion and a stop portion to allow for rotational movement between said first part and said second part in a direction consistent with said closing of said throttle control when said pawl is engaged with said ratchet ring.

36. System according to claim 31, wherein said at least partially immobilizing said throttle control comprises immobilizing opening and closing of said throttle control.

37. System according to claim 36, wherein said first part comprises a ratchet ring arrangement having a plurality of ratchet teeth circumferentially disposed on said ring, and said stop comprises a pawl configured for being selectively engaged and disengaged with said ratchet teeth responsive to said locking element being attached to or detached from, respectively, said mounting unit, and wherein said ratchet teeth are configured for preventing rotational movement between said first part and said second part in a direction consistent with said opening or said closing of said throttle control when said pawl is engaged with said ratchet ring.

38. A handlebar balance weight replacement kit for a motorcycle, the motorcycle comprising a balance weight unit on at least one end of a respective handlebar of the motorcycle, said kit comprising a locking system as defined in claim 20, wherein said locking system has a weight substantially similar to a weight of the balance weight unit, and wherein said locking system is configured for being affixed to said respective handlebar after said balance weight unit is removed therefrom.

39. A motorcycle comprising at least one system as defined in claim 1.

40. A method for modifying a motorcycle comprising a handlebar and at least one brake disk, the method comprising the steps of (a) providing a system as defined in claim 1, and (b) affixing the system to an end of the handlebar.

41. Method according to claim 40, wherein prior to step (b), a balance weight originally provided at said end of the handlebar is removed.
